(19) United States
(12) Patent Application Publication
(10) Pub. No.: US 2018/0029905 A1
(43) Pub. Date: Feb. 1, 2018

(54) THERMORESPONSIVE POLYMERS FOR AQUEOUS APPLICATIONS

(71) Applicant: PHILLILPS 66 COMPANY, Houston, TX (US)

(72) Inventors: Amit Palkar, Bartlesville, OK (US); Paula Delgado, Bartlesville, OK (US); Sriram Satya, Bartlesville, OK (US)

(73) Assignee: PHILLIPS 66 COMPANY, Houston, TX (US)

(21) Appl. No.: 15/662,562

(22) Filed: Jul. 28, 2017

Related U.S. Application Data
(60) Provisional application No. 62/368,577, filed on Jul. 29, 2016.

(51) Int. Cl. C02F 1/56; C08F 220/56; C08F 220/36

(52) U.S. Cl. CPC C02F 1/56; C08F 220/36; C08F 220/56; C02F 2103/365

(57) ABSTRACT

A method of first introducing a thermoresponsive polymer with an upper critical solubility temperature into an aqueous solution. The temperature of the thermoresponsive polymer can be equal to or greater than the upper critical solubility temperature of the thermoresponsive polymer. The method then separates contaminants within the aqueous solution with the thermoresponsive polymer to form aggregates.

### CROSS-REFERENCE TO RELATED APPLICATIONS

This application is a non-provisional application which claims the benefit of and priority to U.S. Provisional Application Ser. No. 62/368,577 filed Jul. 29, 2016, entitled “Thermoresponsive Polymers for Aqueous Applications,” which is hereby incorporated by reference in its entirety.

### STATEMENT REGARDING FEDERALLY SPONSORED RESEARCH OR DEVELOPMENT

None.

### FIELD OF THE INVENTION

This invention relates to thermoresponsive polymers.

### BACKGROUND OF THE INVENTION

Refineries can generate a significant amount of wastewater that has been in contact with hydrocarbons. Wastewater can also include water rejected from boiler feedwater pretreatment processes (or generated during regenerations). Wastewater can also refer to cooling tower blowdown stream, desalter effluent, sour water, tank bottom draws, spent caustic or even once-through cooling water that leaves the refinery.

Contaminated wastewater is typically sent to either a wastewater treatment plant that is located at the facility, or it can be pretreated and sent to the local publicly owned treatment works or third-party treatment facility for further treatment. Currently, refinery wastewater treatment plants consist of primary and secondary oil/water separation, followed by biological treatment and tertiary treatment (if necessary).

There exists a need for separation process to remove contaminants from wastewater streams during any stage of the refinery process.

### BRIEF SUMMARY OF THE DISCLOSURE

A method of first introducing a thermoresponsive polymer with an upper critical solubility temperature into an aqueous solution. The temperature of the thermoresponsive polymer can be equal to or greater than the upper critical solubility temperature of the thermoresponsive polymer. The method then separates the contaminants within the aqueous solution through interaction with the thermoresponsive polymer to form aggregates.

An alternate method is also described of first introducing a thermoresponsive polymer with an upper critical solubility temperature into a wastewater stream, wherein the temperature of the thermoresponsive polymer and the wastewater stream is equal to or greater than the upper critical solubility temperature of the thermoresponsive polymer. The temperature of the wastewater stream is then decreased to a temperature below that of the upper critical solubility temperature. The method then separates the contaminants within the aqueous solution through interaction with the thermoresponsive polymer to form aggregates.

Yet another method is describe of first heating a thermoresponsive polymer with an upper critical solubility temperature at a temperature equal to or greater than the upper critical solubility temperature of the thermoresponsive polymer. The method then introduces the thermoresponsive polymer into a wastewater stream wherein the wastewater stream is at a temperature below that of the upper critical solubility temperature of the thermoresponsive polymer. The method then separates the contaminants within the aqueous solution through interaction with the thermoresponsive polymer to form aggregates.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts a method of separating contaminants within an aqueous solution.

FIG. 2 depicts a NMR comparison of a thermoresponsive polymer made with an organic solvent versus one made with water.

FIG. 3 depicts a ¹H NMR of 2-(3-(4-methyl-6-oxo-1,6-dihydropyrimidin-2-yl)ureido)ethyl acrylate.

FIG. 4 depicts a ¹³C NMR of 2-(3-(4-methyl-6-oxo-1,6-dihydropyrimidin-2-yl)ureido)ethyl acrylate.

FIG. 5 depicts a reaction scheme.

FIG. 6 depicts a reaction scheme.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

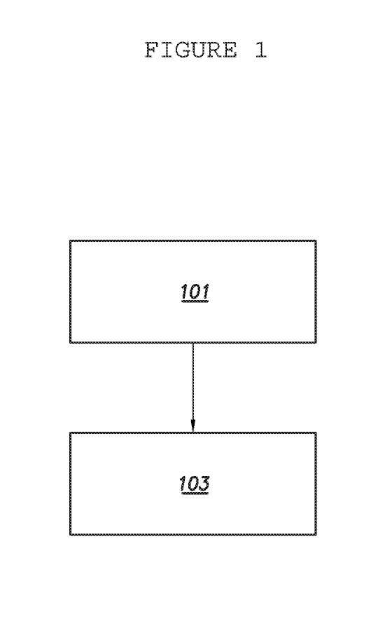

A method of forming aggregates from contaminants within an aqueous solution is depicted in FIG. 1. The method first introduces a thermoresponsive polymer with an upper critical solubility temperature into an aqueous solution (101). The temperature of the thermoresponsive polymer can be equal to or greater than the upper critical solubility temperature of the thermoresponsive polymer. The method then separates contaminants within the aqueous solution through interaction with the thermoresponsive polymer to form aggregates (103).

It is envisioned that this method can be incorporated into any location within the refinery in which there is, or there can be, a difference in temperature. For example it is possible for aggregates to be formed within a continuous pipeline. In this embodiment the thermoresponsive polymer would be injected into the upstream portion of an aqueous pipeline. As the aqueous fluid flows through the pipeline a decrease in temperature would be achieved either through radiant heat loss or some other external means. The contaminants within the aqueous solution are envisioned to flocculate and form aggregates which can then be filtered out of the aqueous pipeline or flocculated in a flocculation chamber. The separation can be done through any known method including filtration, skimming or settling. The separation chamber can be an induced or a dissolved gas flotation unit.

This method can be done multiple times within a refinery to remove the contaminants as long as a difference in temperature between the polymer solution and wastewater stream is present. Other locations within a refinery where this process can be implemented include different tanks. Generally, locations where aqueous solutions need to be remediated within a refinery include: process water from the desalter effluent, sour water, tank bottom draws or spent caustic; cooling water from the cooling towers; condensate blowdowns from the boiler blowdown, steam generator blowdown, unrecovered condensate; raw water; laboratory wastewater; hydrocracking wastewater; FCC wastewater; coking wastewater; alkylation and polymerization wastewater; and reforming wastewater.

It is important to know that this method is not limited to refinery wastewater solutions. In other embodiments it is envisioned that the use of thermoresponsive polymers with an upper critical solubility temperature can also be used in other types of aqueous environments such as produced water from oil and gas production sites, sewage wastewater treatment plants, nuclear wastewater treatment locations, agriculture wastewater treatment locations or even leachate wastewater treatment locations.

One aspect of the method is to select a thermoresponsive polymer capable of operating in the temperature zone of the location within the refinery. Different pipes and tanks within a refinery have different temperature zones and associated drops in temperature. It can be an aspect of the method to ensure that the upper critical solubility temperature of the thermoresponsive polymer is higher than that of the refinery location. By ensuring that the upper critical solubility temperature of the thermoresponsive polymer is higher than that of the refinery location it reduces the need to externally heat the aqueous solution of the refinery.

In one embodiment once the aggregates are separated from the aqueous solution the now remediated aqueous solution is sent back towards to the refinery to be reused. For example different uses of water in a refinery can include process water, boiler feed water, cooling water, potable water, fire water or utility water.

In one embodiment thermoresponsive polymers with upper critical solubility temperatures can be described as

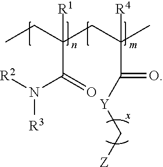

In this polymer R1 and R4 can be independently selected from the group consisting of H and alkyl groups; R2 and R3 can be independently selected from the group consisting of H, alkyl, olefinic, aromatic, heterocyclic, halogen, ammonium, nitroxides, nitrates, nitrite amides, amines, esters, ethers, carboxylic acids, acyl chlorides, alcohols, nitriles, phosphates, phosphonates, sulfates, sulfonates, sulfide, sulfite, thiol, and combinations thereof; Y can be selected from the group consisting of O, N and S; Z can be a hydrogen bonding group that is at least triple bonded or higher and X are methylene groups. It is theorized that such a polymer can be a water soluble thermoresponsive polymer.

In one embodiment, the repeat units of the n polymer can be from n=1 to n=100,000,000. In another embodiment, the repeat units of the m polymer can be from m=1 to m=100,000,000.

In one embodiment Z can be selected from

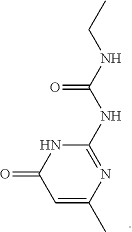

In another embodiment Z can be selected, from the group consisting of

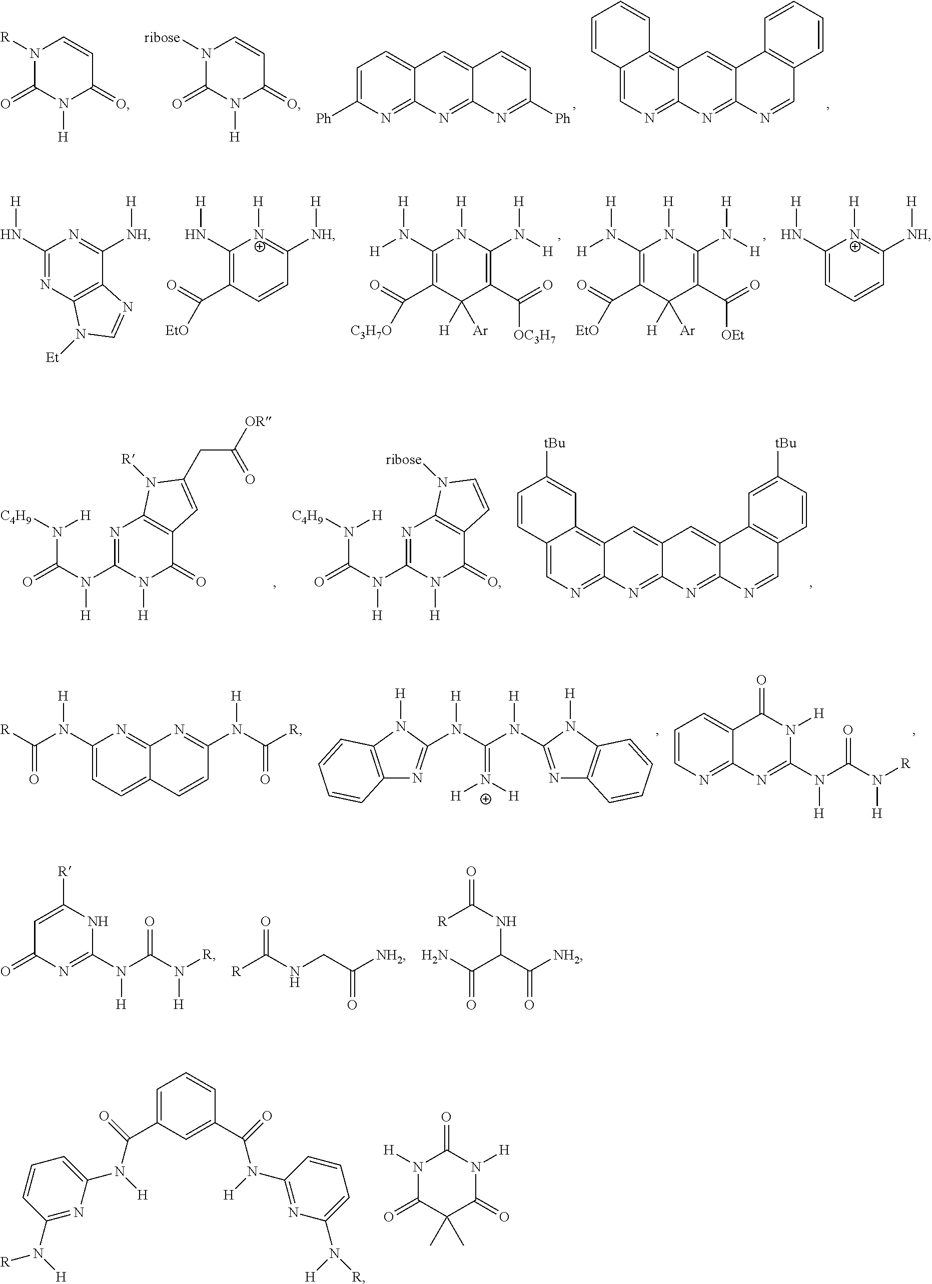

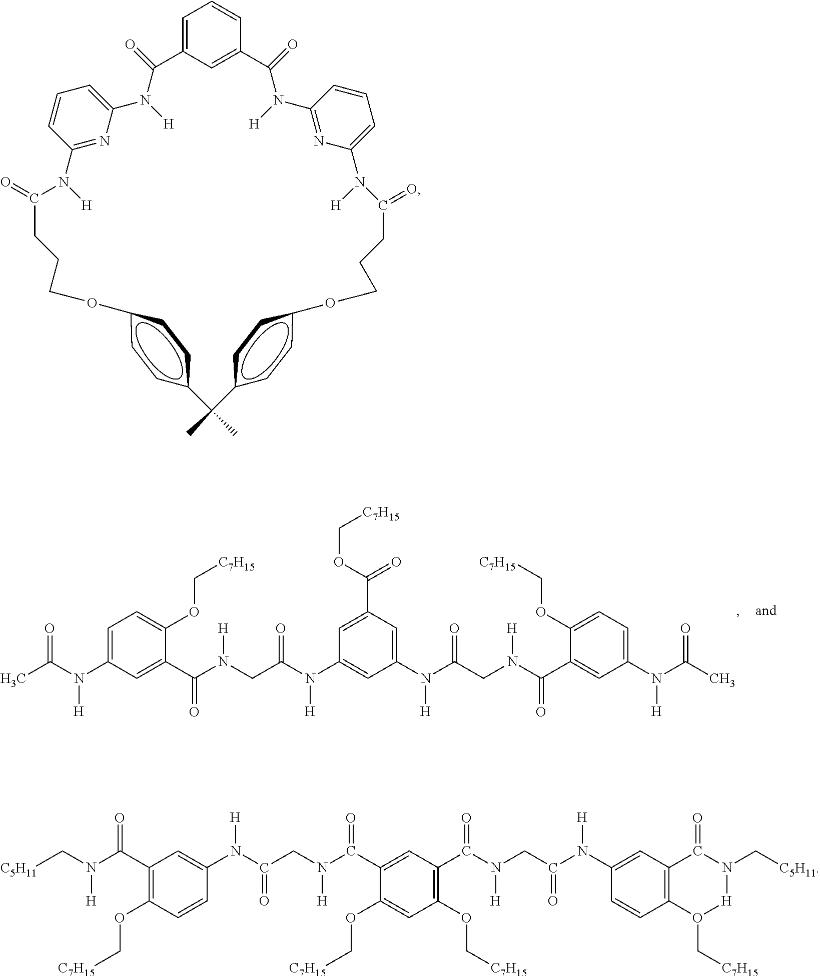

The number of methylene groups of X can range anywhere from 0 to 20, in other embodiments X can range anywhere from 0 to 25, 0 to 20, 0 to 15, 0 to 10 even from 0 to 5.

In one embodiment, R2 and R3 can be independently selected from the group consisting of C₁-C₁₀ alkyls, C₁-C₁₀ olefinics, aromatic, heterocyclic, halogen, ammonium, nitroxides, nitrates, nitrite amides, amines, esters, ethers, carboxylic acids, acyl chlorides, alcohols, nitriles, phosphates, phosphonates, sulfates, sulfonates, sulfide, sulfite, thiol, and combinations thereof.

The polymer can have an upper critical solubility temperature. An upper critical solubility temperature in water is the critical temperature above which the polymer is soluble in aqueous solutions. It is theorized that the upper critical solubility temperature can be used to separate the contaminants within the aqueous solution.

The polymer can be made using any known method to make the polymer. One such method involves by mixing

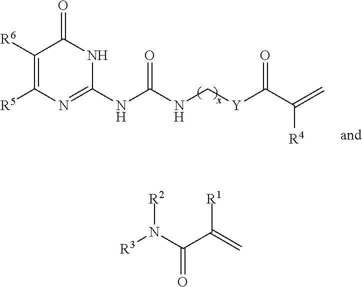

in the presence of a solvent to form a monomer solution. An initiator is then added to the monomer solution to form the polymer. In this method, R1 and R4 can be independently selected from the group consisting of H and alkyl groups; R2 and R3 can be independently selected from the group consisting of H, alkyl, olefinic, aromatic, heterocyclic, halogen, ammonium, nitroxides, nitrates, nitrite amides, amines, esters, ethers, carboxylic acids, acyl chlorides, alcohols, nitriles, phosphates, phosphonates, sulfates, sulfonates, sulfide, sulfite, thiol, and combinations thereof; Y can be selected from the group consisting of O, N and S; R5 and R6 can be independently selected from the group consisting of alkyl, olefinic, heterocyclic, halogens, ammonium, carboxylic, amines, esters, amides and combinations thereof; and X are methylene groups.

Upon completion of polymerization, the polymer exhibits thermoresponsive behavior through hydrogen bonding. When bonded together the hydrogen bonding groups can be either by complementary or self-complementary bonded through hydrogen bonding groups.

In one embodiment, the average molecular weight of the thermoresponsive polymer is greater than 50,000. In other embodiments, the average molecular weight is greater than 60,000, 62,000, 65,000, 70,000, 71,000, 75,000 even greater than 80,000.

In one embodiment the solvent can be an organic solvent. Non-limiting examples of solvents that can be used include dimethyl sulfoxide, dimethyl formamide, ethyl acetate, methanol, dioxane, tetrahydrofuran, acetone, methylene chloride, chloroform, and toluene.

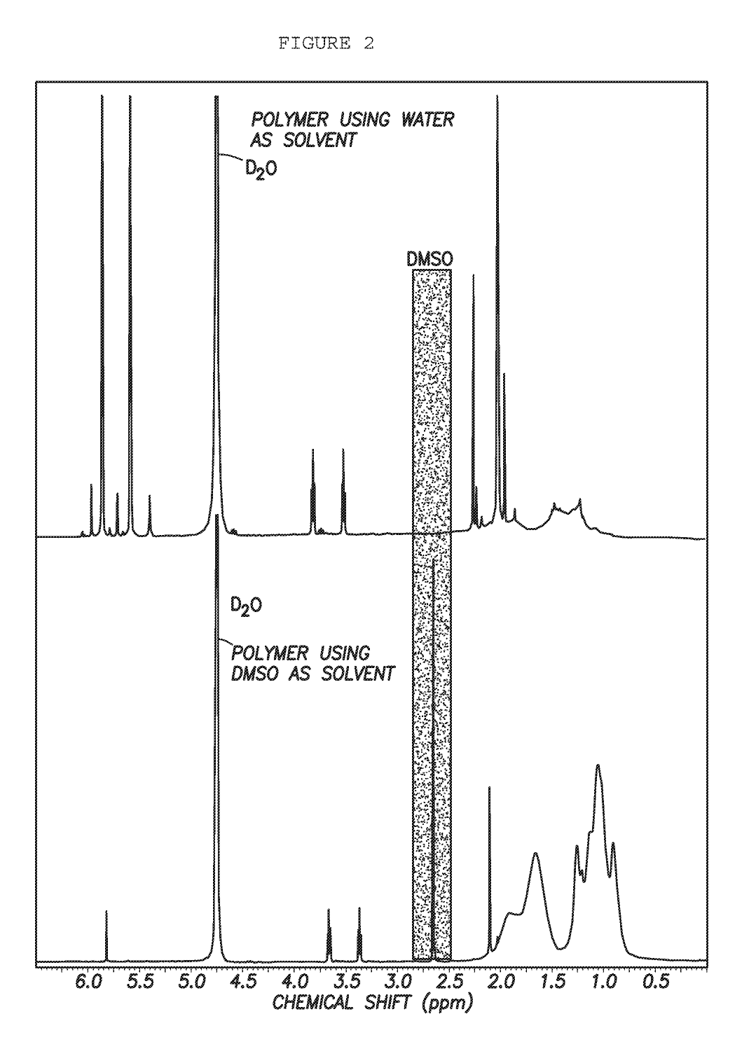

In other embodiments, the solvent can be water with inorganic salts, such as electrolyte solutions. Any conventionally known inorganic salts can be used. FIG. 2 depicts a NMR comparison of using an organic solvent as a solvent versus using water. As shown in the Figure, the organic solvent of dimethyl sulfoxide can be difficult to remove from the polymer and can result in a polymer with an organic solvent contaminant. When the solvent is water it is envisioned that the purification step can be optional.

In another embodiment the initiator can be an addition-type initiator, such as radical initiators. Non-limiting examples of addition-type initiators that can be used include azo initiators, azobisisobutyronitriles, peroxides, persulfates and redox systems. In one embodiment the initiator can also be a UV initiator. Non-limiting examples of peroxide initiators include: persulfate salts, hydrogen peroxide, alkyl peroxide, alkyl peroxyesters, peroxydicarbonates, hydroperoxides and combinations thereof. Non-limiting examples of azo initiators include: 4,4′-azobis(4-cyanovaleric acid), 4,4′-azobis-(4-cyanopentanoic acid), 2,2′-azobis(2-methylpropionamidine)dihydrochloride, 2,2′-azobis[2-(2-imidazolin-2-yl)propane]dihydrochloride, 2,2′-azobis[N-(2-carboxyethyl)-2-methylpropionamidine] tetrahydrate, 2,2′-azobis[2-(2-imidazolin-2-yl)propane], 2,2′-azobis[2-methyl-N-(2-hydroxyethyl)propionamide], 2,2′-azobis-(2-amidinopropane) dihydrochloride, 2,2′-azobis(N,N′-dimethylene isobutyramidine) dihydrochloride, 2,2′-azobis(N,N′-dimethylene isobutyramidine), 2,2′-azobis-(isobutyramide)dehydrate, 2,2′-azobis-(N-ethylamidinopropane hydrochloride), 2,2′-azobis-(N,N′-dimethyleneamidinopropane hydrochloride), 2,2′-azobis(2-propane-2-carboxylic acid), 2,2′-azobis-(2-methyl-N-(2-hydroxyethyl))propionamide, 2,2′-azobis-[2-methyl-N-(1,1-bis(hydroxymethyl)]propionamide, 2,2′-azobis-[2-methyl-N-(1,1-bis(hydroxymethyl)-2-hydroxyethyl)]propionamide and combinations thereof.

The reaction time to create the polymers can range from less than ten minutes, less than 15 minutes, less than half an hour, less than an hour, less than 2 hours, less than 4 hours, or even less than 24 hours. The reaction time is theorized to be dependent upon the starting materials.

In one embodiment azobisisobutyronitrile can be dissolved in the same or different solvent in molar ratios of 1:5 to 1:10000 with respect to the molar concentration of the monomer solution to form the thermoresponsive polymer. Examples of ranges in molar ratios from 1:5, 1:10, 1:25, 1:50 1:75, 1:100, 1:500, 1:1000, 1:1500, 1:2000, 1:2500, 1:3000, 1:3500, 1:4000, 1:4500, 1:5000, 1:5500, 1:6000, 1:6500, 1:7000, 1:7500, 1:8000, 1:8500, 1:9000, 1:9500, 1:10000 or any range in between the numbers given. In one embodiment the monomer solution is heated to a temperature greater than 30° C., 35° C., 40° C., 45° C., 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., or even greater than 200° C. The heating of the monomer solution can occur either by directly heating the monomer solution, incorporating the monomer solution into another solution with a greater temperature than the monomer solution, or any other method known of heating the monomer solution.

In another embodiment the mixing of the monomer solution occurs at an elevated temperature. Examples of the temperature in which the monomer solution can be mixed in include temperature greater than 30° C., 35° C., 40° C., 45° C., 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., or even greater than 200° C. The mixing of the monomer solution at an elevated temperature can occur by heating one component of the monomer solution, heating multiple components of the monomer solution or any other known method of mixing the monomer solution at an elevated temperature. This monomer solution can then be optionally degassed at room temperature or the temperatures below. The reaction time can be any time necessary for conversion of monomers,

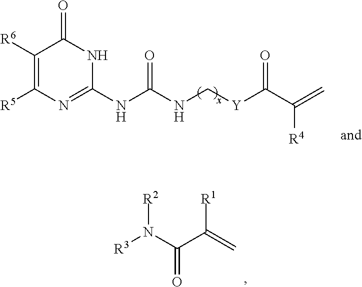

within the monomer solution to polymers. Additionally, the reaction time can be any time necessary for the reaction of monomers,

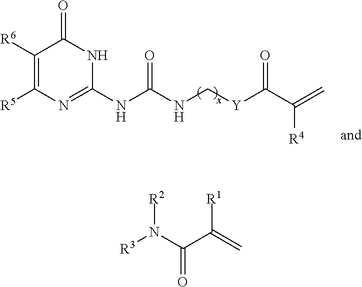

to take place. In one embodiment the thermoresponsive polymer is purified in a polar solvent, such as alcohol. Examples of type of polar solvents that can be used include ethanol, methanol, acetone, water, tetrahydrofuran, ether and ethyl acetate.

In one embodiment the ratio of 2-(3-(4-methyl-6-oxo-1,6-dihydropyrimidin-2-yl)ureido)ethyl methacrylate to methacrylamide in monomer solution ranges in mole percentage from 0.01:99.99, 0.05:99.5, 1:99, 2:98, 3:97, 4:96, 5:95, 6:94, 7:93, 8:92, 9:91, 10:90, 11:89, 12:88, 13:87, 14:86, 15:85, 16:84, 17:83, 18:82, 19:81, 20:80, 21:79, 22:78, 23:77, 24:76, 25:75, 26:74, 27:73, 28:72, 29:71, 30:70, 31:69, 32:68, 33:67, 34:66, 35:65, 36:64, 37:63, 38:62, 39:61, 40:60, 41:59, 42:58, 43:57, 44:56, 45:55, 46:54, 47:53, 48:52, 49:51, 50:50 or any range in between the numbers given.

There are a variety of methods in which the thermoresponsive polymer can be incorporated into the wastewater. In one method it is possible that the thermoresponsive polymer is directly added into the wastewater. In another method, the thermoresponsive polymer is dissolved in a chemical solution, which solubilizes the polymer, and then incorporated in the wastewater. In one example the chemical is Sodium Chloride (NaCl) solution. The amount of chemical added can be from about 0.0001 wt % to about 30 wt %, or from any amount greater than about 0.0005 wt %, 0.001 wt %, 0.005 wt %, 0.01 wt %, 0.05 wt %, 0.1 wt %, 0.5 wt %, 1 wt %, to any amount smaller than about 25 wt %, 20 wt %, 15 wt %, 10 wt %, or even about 5 wt %.

Examples of wastewater can be from refineries such as desalter effluent, from paper making facilities, from municipal water treatment facilities or any other facility that produces wastewater. Wastewater can be broadly defined as any aqueous environment that has high inorganic salts content (broadly defined as greater than or equal to 100 ppm, greater than or equal to 200 ppm or around 1000 ppm), suspended solids (<500 ppm), hydrocarbons (as free and/or emulsified oil), other organics and inorganics or combinations thereof.

The following examples of certain embodiments of the invention are given. Each example is provided by way of explanation of the invention, one of many embodiments of the invention, and the following examples should not be read to limit, or define, the scope of the invention.

### Example 1

The amounts of 2-(3-(4-methyl-6-oxo-1,6-dihydropyrimidin-2-yl)ureido)ethyl methacrylate (MAUPy) and methacrylamide (MAAm) listed in Table 1, along with 1.2 mL of dimethyl sulfoxide solvent, were added to a 50 mL reaction flask equipped with a stir bar. The chemicals started to dissolve after immersing the flask in a 70° C. oil bath under strong stirring. When the solution was homogenous, the system was degassed by freeze-pump thaw, or by bubbling an inert gas or by using an appropriate degassing method. After degassing, the solution was again immersed into the 70° C. oil bath to preserve the monomers in solution. In a separate small vial, the corresponding amount of azobisisobutyronitrile (AIBN) was dissolved in 100 μL of dimethyl sulfoxide solvent (DMSO), and subsequently degassed. The polymerization started after the addition of the azobisisobutyronitrile solution to the reaction flask at 70° C. under an inert atmosphere. These conditions were maintained for 4 h. The polymerization was then quenched by exposing the reaction mixture to air at room temperature or by adding a radical inhibitor. Polymers were purified by 24 h of stirring in methanol (100 mL) followed by 24 h of dialysis in methanol (3000 g mol⁻¹ cut off).

TABLE 1

| | MAAm | | MAAm | |
|---|---|---|---|---|
| Sample | ratio | MAUPy amount | amount | AIBN amount |
| Poly(MAUPy)-100 | 0 | 100 mg, | | 0.117 mg, |
| | | 3.6 × 10−1 mmol | | 7.1 × 10−4 mmol |
| Poly(MAUPy-MAAm)- | 30 | 100 mg, | 13.01 mg, | 0.17 mg, |
| 70 | | 3.6 × 10−1 mmol | 0.15 mmol | 1.0 × 10−3 mmol |
| Poly(MAUPy-MAAm)- | 50 | 100 mg, | 30.37 mg, | 0.23 mg, |
| 50 | | 3.6 × 10−1 mmol | 0.36 mmol | 1.4 × 10−3 mmol |
| Poly(MAUPy-MAAm)- | 80 | 100 mg, | 121.48 mg, | 0.59 mg, |
| 20 | | 3.6 × 10−1 mmol | 1.43 mmol | 3.6 × 10−3 mmol |
| Poly(MAUPy-MAAm)- | 90 | 100 mg, | 273.32 mg, | 1.17 mg, |
| 10 | | 3.6 × 10−1 mmol | 3.24 mmol | 7.1 × 10−3 mmol |
| Poly(MAUPy-MAAm)-5 | 95 | 100 mg, | 577.01 mg, | 2.34 mg, |
| | | 3.6 × 10−1 mmol | 6.78 mmol | 1.4 × 10−2 mmol |
| Poly(MAUPy-MAAm)-2 | 98 | 100 mg, | 1.49 g, | 5.86 mg, |
| | | 3.6 × 10−1 mmol | 17.49 mmol | 3.6 × 10−2 mmol |

Table 2 depicts the solubility of different samples of Poly(MAUPy-MAAm)

TABLE 2

| | | | Solubility |
|---|---|---|---|
| | | Solubility | in water |
| | MAAm | in water | at 175° F. with |
| Sample | ratio | 175° F. | 1 wt % NaCl |
| Poly(MAUPy-MAAm)-70 | 30 | No | Yes |
| Poly(MAUPy-MAAm)-50 | 50 | No | Yes |
| Poly(MAUPy-MAAm)-20 | 80 | No | Yes |
| Poly(MAUPy-MAAm)-10 | 90 | No | Yes |
| Poly(MAUPy-MAAm)-5 | 95 | Yes | Yes |
| Poly(MAUPy-MAAm)-2 | 98 | Yes | Yes |

### Example 2

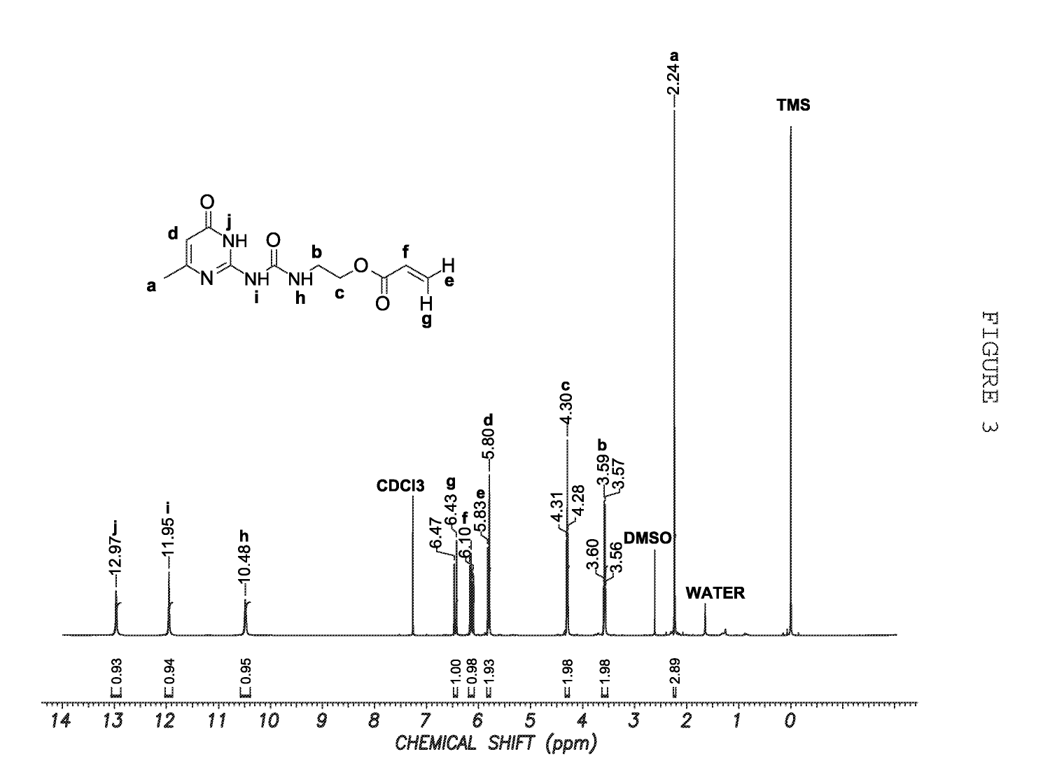

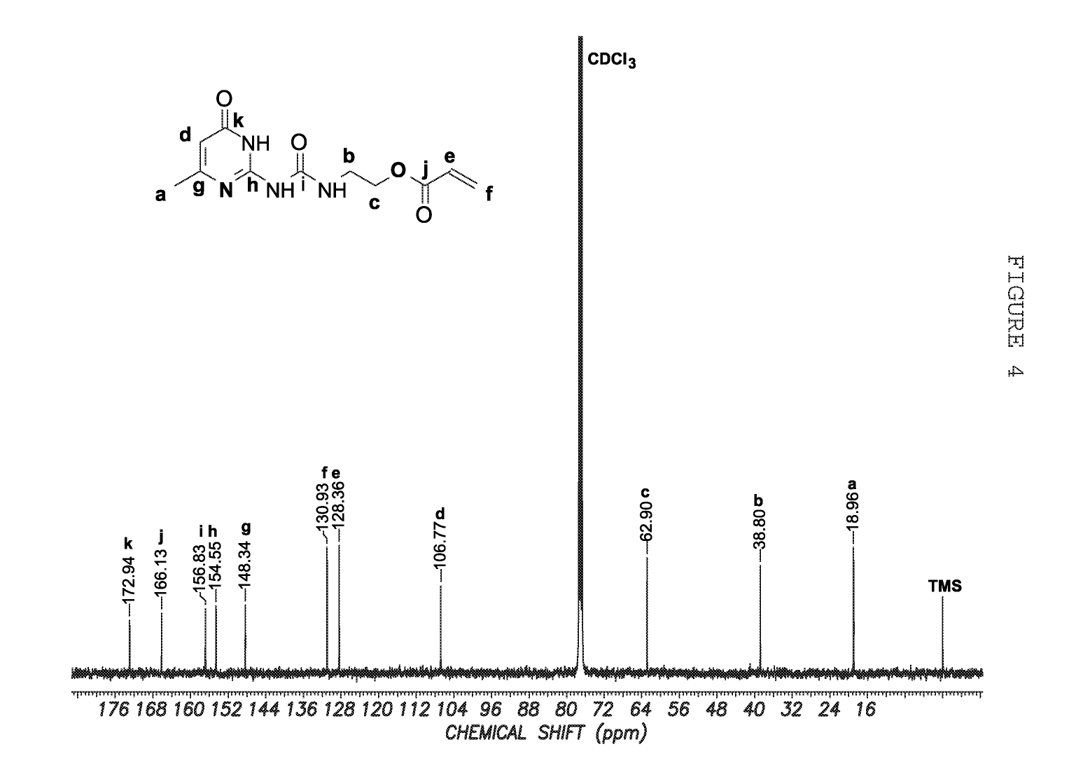

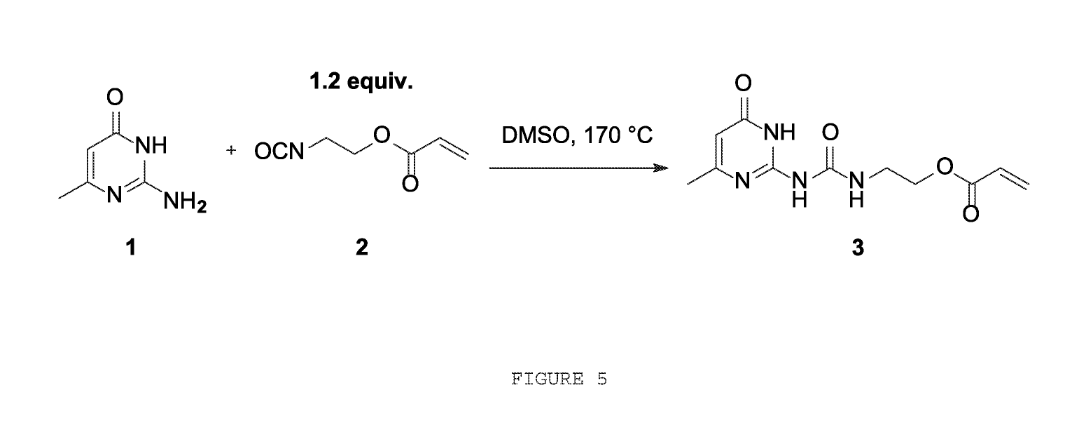

Synthesis of 2-(3-(4-methyl-6-oxo-1,6-dihydropyrimidin-2-yl)ureido)ethyl acrylate (AUPy): To a round bottom flask equipped with a magnetic stir bar 6-methyl isocytosine (4.0 g, 32 mmol) and 50 mL dimethyl sulfoxide solvent were added. In order to dissolve the 6-methyl isocytosine in the DMSO, the flask was sealed with a septum and heated to 170° C. using an oil bath. Upon dissolution, the oil bath was removed and 2-isocyanatoethyl acrylate (4.8 mL, 38 mmol) was added via syringe. The reaction was then quenched by cooling the reaction flask in a 2-propanol/CO₂₍ₛ₎ bath. After 5-10 min of cooling the reaction flask was thawed using an ambient temperature water bath and the white solid was washed 3×1000 mL with cold water (stirring for >60 min per wash), filtered, and dried at reduced pressure overnight to yield 7.57 g of white powder (89% yield). FIG. 3 depicts the H NMR of the AUPy and FIG. 4 depicts the C NMR of the AUPy. FIG. 5 depicts the reaction scheme for this reaction.

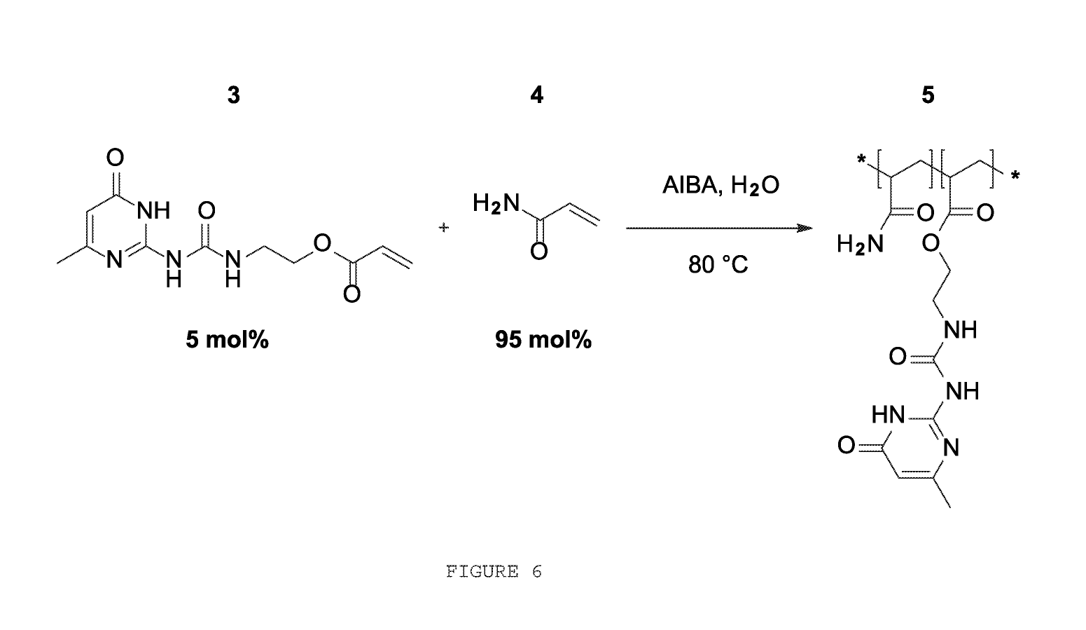

Synthesis of Poly[acrylamide-co-2-(3-(4-methyl-6-oxo-1,6-dihydropyrimidin-2-yl)ureido)ethyl acrylate], p(AUPy-AAm)-5: To a 25 mL round bottom flask equipped with a magnetic stirrer, 0.20 g AUPy, 1.02 g acrylamide (AAm), 0.05 g sodium carbonate, and 12 mL water was added. The flask was immersed in an 80° C. oil bath to dissolve the solids and the mixture was degassed by argon flow for 30 minutes. In a 2 mL vial, 0.0065 g 2,2′-Azobis(2-methylpropionamidene) dihydrochloride (AIBA) was added to 0.2 mL water. The AIBA solution was degassed by argon flow and transferred to the round bottom flask using a 1 mL syringe to initiate the polymerization. This method generates p(AUPy-AAm)-5, a copolymer that consists of 95 mol % AAm and 5 mol % AUPy and with a monomer to initiator ratio of 600 to 1. FIG. 6 depicts the reaction scheme for this reaction.

The reaction mixture was allowed to polymerize for 4 hours at a stir speed of 500 rpm, and an opaque and viscous polymer solution was obtained. The polymer was precipitated from solution as white solids by slowly adding equal volume of acetone to reaction mixture. The polymer-acetone-water slurry was separated by centrifugation (5000 rpm, 5 min), the liquid was decanted, and the resulting solid material was dried at reduced pressure to yield 1.19 g of white powder (97% yield).

### Example 3

Random copolymer of 5 mol % of 2-(3-(4-methyl-6-oxo-1,6-dihydropyrimidin-2-yl)ureido)ethyl methacrylate and 95 mol % of methacrylamide were synthesized in water and inorganic salts and purified with perchlorate (sample DI-Perchlorate), synthesized in water and inorganic salts and purified with hydrochloric acid (sample DI-HCl), and synthesized in DMSO and washed in water (sample DMSO-DI). The apparent viscosity, specific viscosity and weight average molecular weight are shown in Table 3.

TABLE 3

| | Apparent Viscosity | Specific Viscosity | |
|---|---|---|---|
| Polymer | mPa-s | (a.u.) | Mw (g/mol)² |
| DI-Perchlorate | 1.051 ± 0.016 | 0.289 | 62,200 ± 6,000 |
| DI-HCl | 1.060 ± 0.014 | 0.300 | 65,600 ± 5,000 |
| DMSO-DI | 1.074 ± 0.002 | 0.317 | 71,000 ± 1,000 |

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method comprising:
introducing a thermoresponsive polymer with an upper critical solubility temperature into an aqueous solution, wherein the temperature of the thermoresponsive polymer is equal to or greater than the upper critical solubility temperature of the thermoresponsive polymer; and
separating contaminants within the aqueous solution with the thermoresponsive polymer to form aggregates.

2. The method of claim 1, wherein the thermoresponsive polymer contains a hydrogen bonding group that is at least triple bonded or higher.

3. The method of claim 2, wherein the hydrogen bonding group is complementary bonded.

4. The method of claim 3, wherein they hydrogen bonding groups is self-complementary bonded.

5. The method of claim 1, wherein the aqueous solution comprises a refinery wastewater stream.

6. The method of claim 1, wherein the aggregates are separated from the aqueous solution.

7. The method of claim 6, wherein the aggregates are removed from the aqueous solution by skimming or precipitating.

8. The method of claim 1, wherein the polymer has an upper critical solubility temperature.

9. The method of claim 1, wherein the polymer is a water soluble thermoresponsive polymer.

10. The method of claim 1, wherein the contaminants are selected from the group consisting of: suspended solids, organics, dissolved metals, suspended metals, sulphides, inorganic salts, ammonia, silica, or combinations thereof.

11. The method of claim 1, wherein the thermoresponsive polymer contains the polymer of 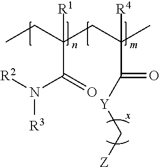
wherein:
R1 and R4 are independently selected from the group consisting of H and alkyl groups;
R2 and R3 are independently selected from the group consisting of H, alkyl, olefinic, aromatic, heterocyclic, halogen, ammonium, nitroxides, nitrates, nitrite amides, amines, esters, ethers, carboxylic acids, acyl chlorides, alcohols, nitriles, phosphates, phosphonates, sulfates, sulfonates, sulfide, sulfite, thiol, and combinations thereof;
Y is selected from the group consisting of O, N and S;
Z is a hydrogen bonding group that is at least triple bonded or higher and
X are methylene groups from about 1-20 carbons.

12. The method of claim 12, wherein Z is selected from

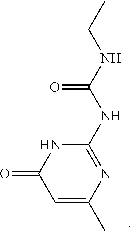

13. The method of claim 12, wherein Z is selected from the group consisting of:

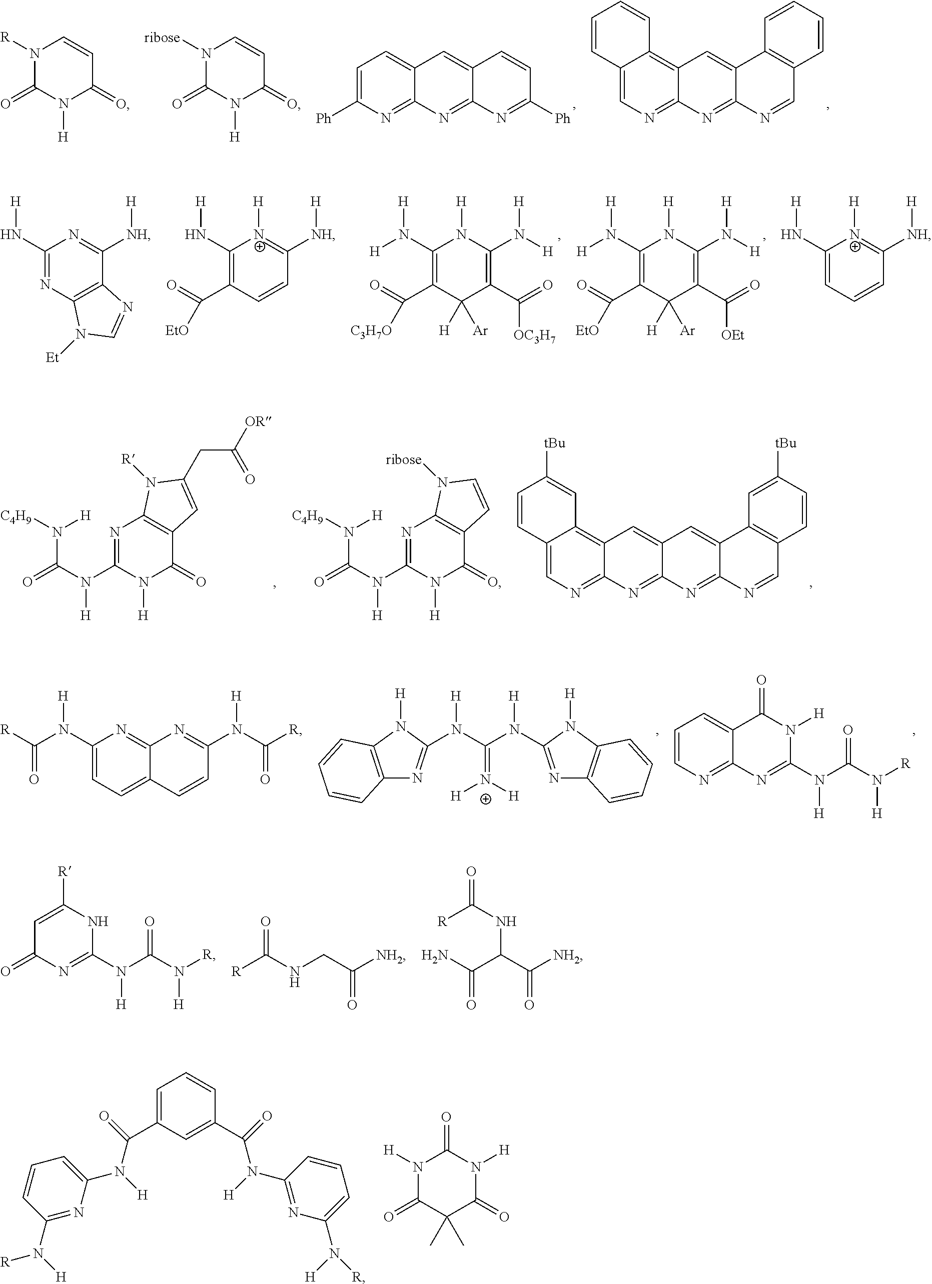

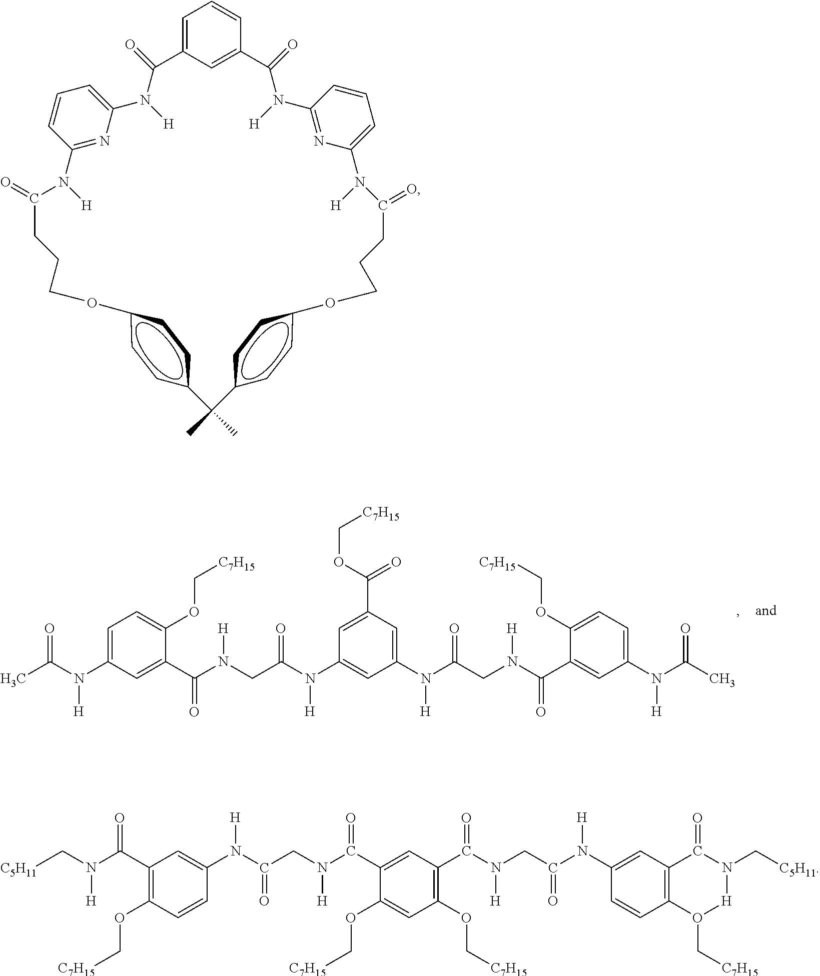

14. The method of claim 1, wherein the temperature of the aqueous solution is decreased below the temperature of the upper critical solubility temperature of the thermoresponsive polymer after the introduction of the thermoresponsive polymer.

15. The method of claim 15, wherein the decrease of temperature of the aqueous solution occurs via radiant heat loss.

16. The method of claim 15, wherein the decrease of temperature of the aqueous solution occurs in a pipe.

17. The method of claim 15, wherein the decrease of temperature of the aqueous solution occurs in a tank.

18. A method comprising:
introducing a thermoresponsive polymer with an upper critical solubility temperature into a wastewater stream, wherein the temperature of the thermoresponsive polymer and the wastewater stream is equal to or greater than the upper critical solubility temperature of the thermoresponsive polymer; and;
decreasing the temperature of the wastewater stream to a temperature below that of the upper critical solubility temperature; and
separating contaminants within the wastewater stream with the thermoresponsive polymer to form aggregates.

19. The method comprising:
heating a thermoresponsive polymer with an upper critical solubility temperature at a temperature equal to or greater than the upper critical solubility temperature of the thermoresponsive polymer;
introducing the thermoresponsive polymer into a wastewater stream wherein the wastewater stream is at a temperature below that of the upper critical solubility temperature of the thermoresponsive polymer; and
separating contaminants within the wastewater stream with the thermoresponsive polymer to form aggregates.
